(19) United States
(12) Patent Application Publication
(10) Pub. No.: US 2014/0071434 A1
(43) Pub. Date: Mar. 13, 2014

(54) OPTICAL TOMOGRAPHIC IMAGE ACQUISITION APPARATUS

(71) Applicants: Masato Tanaka, Yokohama-shi (JP); Takemi Hasegawa, Yokohama-shi (JP); Hiroshi Suganuma, Yokohama-shi (JP); Ichiro Sogawa, Yokohama-shi (JP)

(72) Inventors: Masato Tanaka, Yokohama-shi (JP); Takemi Hasegawa, Yokohama-shi (JP); Hiroshi Suganuma, Yokohama-shi (JP); Ichiro Sogawa, Yokohama-shi (JP)

(73) Assignee: Sumitomo Electric Industries, Ltd., Osaka-shi (JP)

(21) Appl. No.: 14/118,515

(22) PCT Filed: May 17, 2012
(86) PCT No.: PCT/JP2012/062679

§ 371 Date: Nov. 18, 2013

(30) Foreign Application Priority Data
May 18, 2011 (JP) 2011-111476

(51) Int. Cl. G01B 9/02

(52) U.S. Cl. CPC G01B 9/02091
USPC 356/51; 356/479

(57) ABSTRACT

The optical tomographic image acquisition apparatus is based on FD-OCT. A detection unit 50A which detects interference light includes a lens 51, a reflection type diffraction grating 52A, a deflection unit 53, a lens 54), and a light receiving unit 55. The interference light collimated by the lens 51 is divided by the reflection type diffraction grating 52A. Light of each wavelength is output in a different direction according to the wavelength, deflected by the deflection unit 53, and focused on a light receiving surface of the light receiving unit 55 by the lens 54. The optical tomographic image of the object is acquired based on a correspondence relationship between a light radiation position for the object and a deflection angle by the deflection unit 53 and on optical power distribution detected by the light receiving unit 55.

### TECHNICAL FIELD

The present invention relates to an optical tomographic image acquisition apparatus.

### BACKGROUND ART

Optical tomographic image acquisition technology based on optical coherence tomography (OCT) can be used to measure a reflection amount distribution in a depth direction of an object using interference of light. In recent years, this optical tomographic image acquisition technology has been applied to bioinstrumentation since an internal structure of the object can be imaged with high spatial resolution.

An optical tomographic image acquisition apparatus based on OCT branches light output from a light source unit in two to obtain first branch light and second branch light, causes reflected light generated in a reflector when the reflector is irradiated with the first branch light and diffusely-reflected light generated in an object when the object is irradiated with the second branch light to interfere with each other, detects power of interference light resulting from this interference using a detection unit, and analyzes a result of the detection to obtain a reflection information distribution in a depth direction of the object. Further, a tomographic image of the object can be acquired by scanning a light radiation position of the object.

Among OCT methods, TD-OCT (Time Domain-OCT) uses the fact that, when a light source unit which outputs light having a short coherence length is used, an amplitude of interference light decreases if there is a light path length difference between both lights from the light source unit to a detection unit, and the amplitude of the interference light increases only when there is no light path length difference between both lights from the light source unit to the detection unit. In this TD-OCT, since reflection information of a depth direction position of an object according to a position of a reflector can be obtained, a reflection information distribution of the depth direction of the object can be obtained by detecting an interference light amplitude while moving the reflector. However, in TD-OCT, since it is necessary to move the reflector mechanically in order to obtain the reflection information distribution of the depth direction of the object, a time to acquire the tomographic image of the object is long.

On the other hand, among OCT methods, FD-OCT (Fourier Domain-OCT) uses wavelength dependence of an interference signal, in which a time to acquire a tomographic image of an object is shorter in comparison with TD-OCT. When light output from a light source unit is equally divided into a first branch light and a second branch light, intensity P(k) of the interference signal for the light of a wave number k is expressed by the following expression: P(k)=P₀/4{Rₛ+Rₘ+2(RₛRₘ)^{1/2}cos(2 kz)}, where power of the light output from the light source unit is P₀, the wave number of the light is k(=2π/λ), a depth direction position of the object is z, a reflectance in the object is Rₓ and a reflectance in the reflector is Rₘ.

The intensity P(k) of the interference signal for the light of the wave number k vibrates at a period according to the depth direction position z of the object with an amplitude proportional to the reflectance Rₛ to the power of ½ (a square root of the reflectance Rₛ) in the object, as understood from the expression. Therefore, when a spectrum of the interference signal detected by the detection unit is subjected to a

Fourier transform on a wave number axis 2k, a result thereof indicates the reflectance Rₛ in the depth direction position z of the object (i.e., a reflectance distribution in the depth direction). FD-OCT takes advantage of this.

In other words, in FD-OCT, if the light penetrates up to the inside of the object and diffusion and reflection occur in each position along an optical axis when the object is irradiated with the light, the interference signal detected by the detection unit appears in a form in which signals for respective positions inside the object overlap. When a Fourier transform is performed on such an interference signal, a reflection distribution in a depth direction of the object is obtained directly. In FD-OCT, since it is necessary to measure a spectrum, a spectroscope is used as the detection unit. In FD-OCT, since it is not necessary to move a reflector mechanically, a time to acquire the tomographic image of the object is shorter in comparison with TD-OCT.

### CITATION LIST

### Non Patent Literature

[Non-patent Literature 1] Maciej Wojtkowski et al., OPTICS LETTERS, Vol. 28 (2003), p1745

### SUMMARY OF INVENTION

### Technical Problem

In optical tomographic image acquisition technology based on OCT, when the technology is applied to bioinstrumentation, a high scanning speed is necessary in order not to influence from a motion of a living body such as a heartbeat and in order to minimize a load on the living body which is being measured. In FD-OCT in which mechanical scanning of a reflector is unnecessary when a tomographic image in a depth direction of the object is acquired, although a time to acquire the tomographic image of the object is already shorter than in TD-OCT, further speedup is desired.

The present invention has been made to solve the aforementioned problems, and an object of the present invention is to provide an optical tomographic image acquisition apparatus which can acquire an optical tomographic image of an object at a high speed.

### Solution to Problem

An optical tomographic image acquisition apparatus according to an aspect of the present invention includes: (1) a light source unit which outputs light; (2) an interference unit which branches the light output from the light source unit in two to obtain a first branch light and a second branch light, irradiates a reflector with the first branch light, receives reflected light from the reflector resulting from the irradiation, irradiates an object with the second branch light, receives diffusely-reflected light from the object resulting from the irradiation, and causes the reflected light from the reflector and the diffusely-reflected light from the object to interfere with each other to output interference light; (3) a scanning unit which scans a radiation position of the second branch light for the object; (4) a detection unit which detects the interference light output from the interference unit; and (5) an analysis unit which analyzes a result of the detection by the detection unit to obtain an optical tomographic image of the object.

Further, in the optical tomographic image acquisition apparatus according to an aspect of the present invention, the detection unit includes (a) a spectroscopic unit which divides the interference light output from the interference unit and outputs light of each wavelength in a different direction according to the wavelength on a predetermined plane; (b) a deflection unit which deflects the light of each wavelength output from the spectroscopic unit in a deflection angle direction with respect to the predetermined plane; (c) a light focusing unit which focuses the light of each wavelength deflected by the deflection unit; and (d) a light receiving unit which detects power of light arriving at each position on a light receiving surface on which the light is focused by the focusing unit. Also, the analysis unit obtains the optical tomographic image of the object based on a correspondence relationship between the radiation position by the scanning unit and a deflection angle by the deflection unit and on optical power distribution detected by the light receiving unit.

In the optical tomographic image acquisition apparatus according to an aspect of the present invention, light in a band including a wavelength range from 1200 nm to 1400 nm (1200 nm or more and 1400 nm or less) or a wavelength range from 1500 nm to 1800 nm (1500 nm or more and 1800 nm or less) can be output from the light source unit.

### Advantageous Effects of Invention

According to the present invention, it is possible to acquire an optical tomographic image of an object at a high speed.

### BRIEF DESCRIPTION OF DRAWINGS

FIG. 1 is a diagram illustrating a schematic configuration of an optical tomographic image acquisition apparatus 1 of the present embodiment.

FIG. 2 is a diagram illustrating a principle of FD-OCT.

FIG. 3 is a diagram illustrating a principle of FD-OCT.

FIG. 4 is a diagram illustrating an example of a configuration of an interference unit 20 of the optical tomographic image acquisition apparatus 1 of the present embodiment.

FIG. 5 is a diagram illustrating an example of a configuration of the interference unit 20 of the optical tomographic image acquisition apparatus 1 of the present embodiment.

FIG. 6 is a diagram illustrating an example of a configuration of the interference unit 20 of the optical tomographic image acquisition apparatus 1 of the present embodiment.

FIG. 7 is a diagram illustrating an example of a configuration of a detection unit 50 of the optical tomographic image acquisition apparatus 1 of the present embodiment.

FIG. 8 is a diagram illustrating an example of a configuration of the detection unit 50 of the optical tomographic image acquisition apparatus 1 of the present embodiment.

FIG. 9 is a diagram illustrating a state of light receiving in a light receiving unit 55 of the detection unit 50 of the optical tomographic image acquisition apparatus 1 of the present embodiment.

FIG. 10 is a diagram illustrating a measurement unit 40 of the optical tomographic image acquisition apparatus 1 of the present embodiment.

FIG. 11 is a timing chart illustrating operation of the optical tomographic image acquisition apparatus 1 of the present embodiment.

FIG. 12 is a chart summarizing an example of a comparison between a case of the present embodiment and a case of normal FD-OCT.

### DESCRIPTION OF EMBODIMENTS

Embodiments of the present invention will be described in detail with reference to the accompanying drawings. Further, the same elements are denoted by the same reference numerals in explanation of the drawings and repeated explanation is omitted.

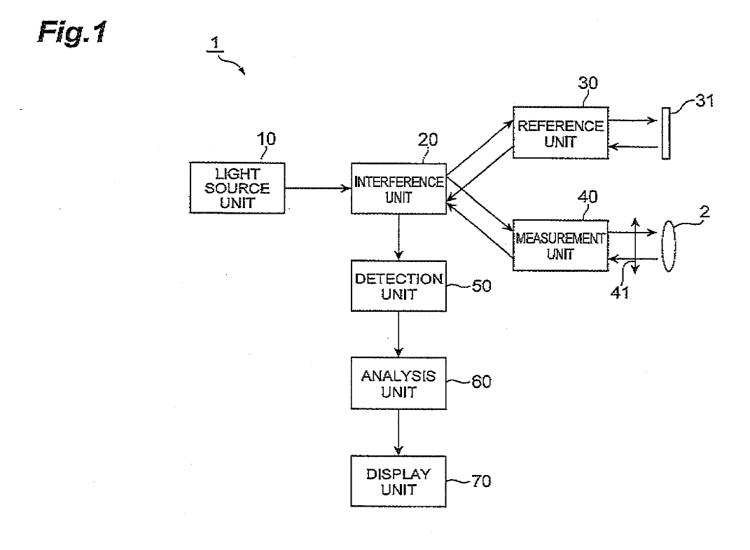

FIG. 1 is a diagram illustrating a schematic configuration of an optical tomographic image acquisition apparatus 1 of the present embodiment. The optical tomographic image acquisition apparatus 1 acquires an optical tomographic image of an object 2 based on FD-OCT and includes a light source unit 10, an interference unit 20, a reference unit 30, a measurement unit 40, a detection unit 50, an analysis unit 60 and a display unit 70.

The light source unit 10 outputs light having a band. In OCT, spatial resolution in a depth direction of the object 2 is inversely proportional to a bandwidth of the light and also depends on a spectrum shape. Therefore, a light source unit which can output light having a broad band and high flatness spectrum may be used as the light source unit 10. For example, an ASE light source that includes glass with a rare-earth element as a light amplification medium and can output broadband spontaneous emission (ASE) light, an SC light source that can output supercontinuum (SC) light whose band is expanded due to a nonlinear optical phenomenon in a light guide, a light source including a super luminescent diode (SLD), or the like may be used.

The interference unit 20 branches the light output from the light source unit 10 in two to obtain first branch light and second branch light, irradiates a reflector 31 with the first branch light and receives reflected light from the reflector 31 resulting from the irradiation, irradiates the object 2 with the second branch light and receives diffusely-reflected light from the object 2 resulting from the irradiation, causes the reflected light and the diffusely-reflected light to interfere with each other, and outputs interference light resulting from this interference to the detection unit 50.

The reference unit 30 includes the reflector 31 and an optical system between the interference unit 20 and the reflector 31, guides the first branch light from the interference unit 20 to the reflector 31 and guides the reflected light from the reflector 31 to the interference unit 20. The measurement unit 40 is an optical system between the interference unit 20 and the object 2, guides the second branch light from the interference unit 20 to the object 2 and guides diffusely-reflected light from the object 2 to the interference unit 20. Further, a scanning unit 41 which scans a radiation position of the object 2 with the second branch light is provided.

The detection unit 50 detects the interference light output from the interference unit 40. The analysis unit 60 analyzes a result of the detection in the detection unit 50 and obtains an optical tomographic image of the object 2. The display unit 70 displays the optical tomographic image of the object 2 obtained by the analysis unit 60.

In FD-OCT, the reflection information distribution in the depth direction of the object 2 can be obtained by measuring the spectrum of the interference signal using the detection unit 50 and performing a Fourier transform on the spectrum using the analysis unit 60. In FD-OCT, since it is not necessary to move the reflector 31 mechanically, a time to acquire the tomographic image of the object 2 is shorter in comparison with TD-OCT.

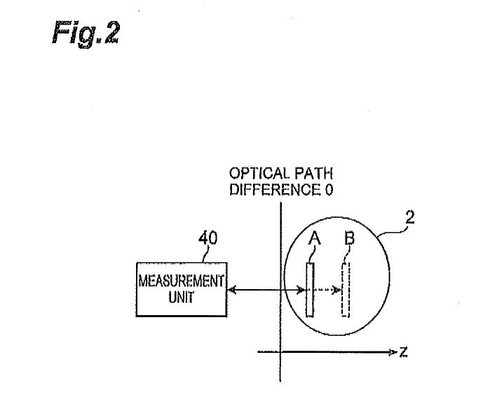

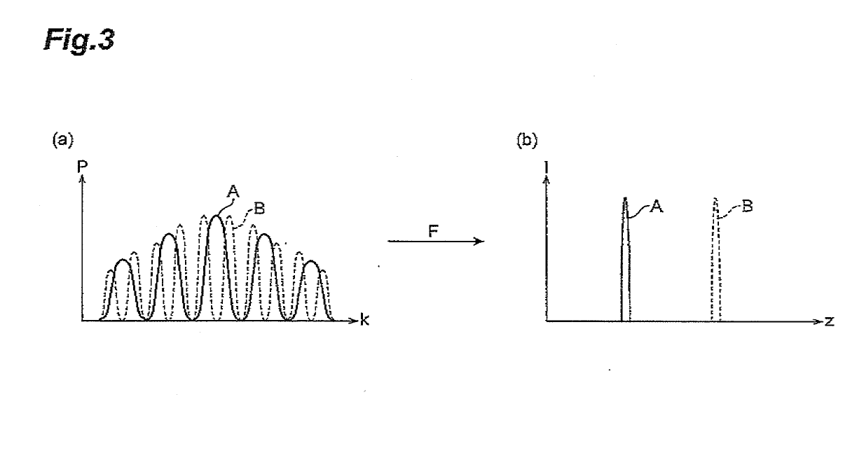

FIGS. 2 and 3 are diagrams illustrating a principle of FD-OCT. Reflective surfaces A and B in two depth direction positions in the object 2 are considered in which a depth direction in the object 2 is a z axis, as illustrated in FIG. 2. In this case, the interference signal detected by the detection unit 50 includes a component of the diffusely-reflected light from the reflective surface A in the object 2 and a component of the diffusely-reflected light from the reflective surface B in the object 2, as illustrated in a part (a) of FIG. 3.

Since the depth direction position of the reflective surface A and the depth direction position of the reflective surface B differ from each other, the components of the diffusely-reflected lights from the respective reflective surfaces A and B included in the interference signal vibrate at different periods according to the depth direction position z of the object 2. Therefore, when the spectrum of the interference signal detected by the detection unit 50 is subjected to a Fourier transform on a wave number axis 2k, a result thereof indicates a reflectance in the depth direction position z of the object 2 (i.e., the reflectance distribution in the depth direction), as illustrated in a part (b) of FIG. 3.

The optical tomographic image acquisition apparatus 1 of the present embodiment is based on FD-OCT, but enables the tomographic image to be acquired at a higher speed than in conventional FD-OCT.

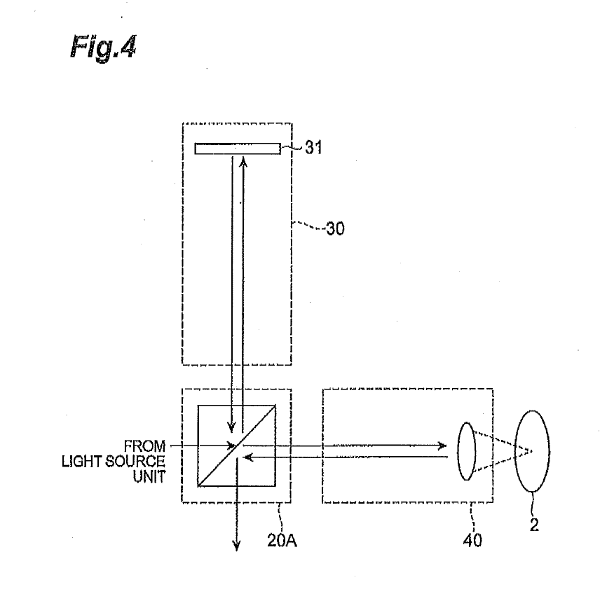

FIGS. 4 to 6 are each diagrams illustrating an example of a configuration of the interference unit 20 of the optical tomographic image acquisition apparatus 1 of the present embodiment.

An interference unit 20A of a first configuration example illustrated in FIG. 4 includes a half mirror and constitutes a Michelson interferometer. The half mirror of the interference unit 20A reflects a part of the light arriving from the light source unit 10 and outputs the resultant light to the reference unit 30 as first branch light, and transmits a remaining part and outputs the remaining part to the measurement unit 40 as second branch light. Further, the half mirror of the interference unit 20A transmits reflected light arriving from the reference unit 30, reflects the diffusely-reflected light arriving from the measurement unit 40, causes the reflected light and the diffusely-reflected light to interfere with each other, and outputs interference light resulting from this interference to the detection unit 50.

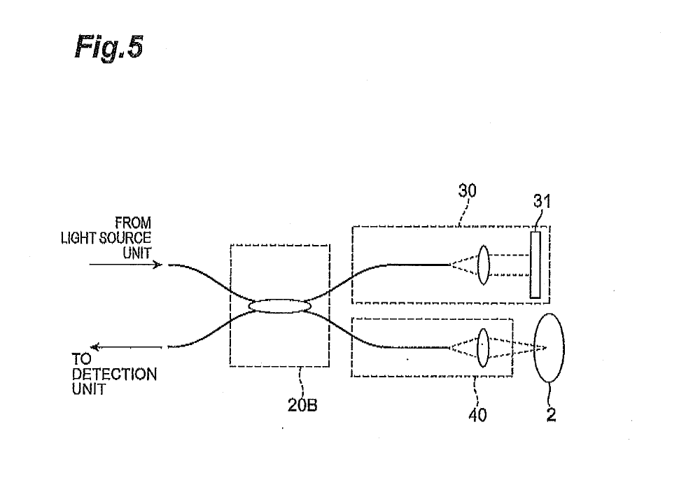

An interference unit 20B of a second configuration example illustrated in FIG. 5 includes an optical coupler and constitutes a Michelson interferometer. The optical coupler of the interference unit 20B branches the light arriving from the light source unit 10 in two, outputs the one (the first branch light) to the reference unit 30, and outputs the other (the second branch light) to the measurement unit 40. Further, the optical coupler of the interference unit 20B causes reflected light arriving from the reference unit 30 and diffusely-reflected light arriving from the measurement unit 40 to interfere with each other, and outputs interference light resulting from this interference to the detection unit 50.

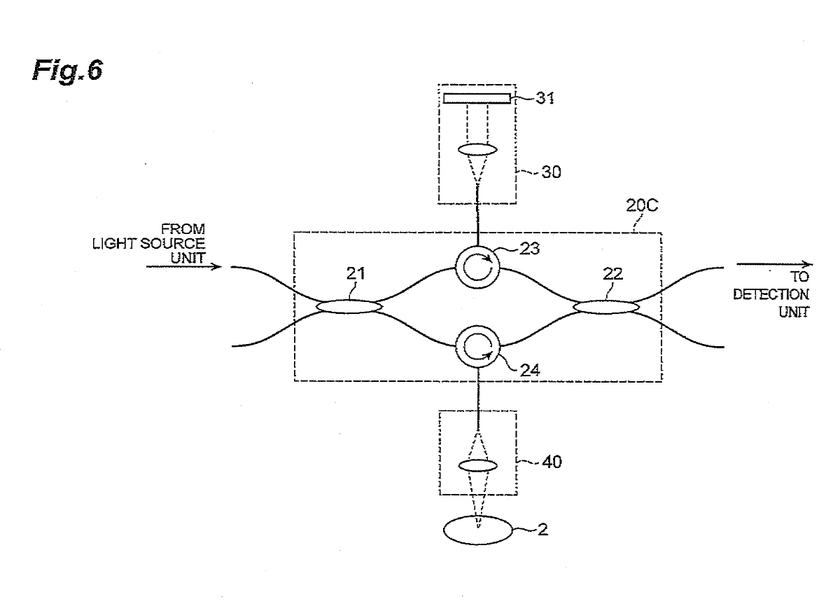

An interference unit 20C of a third configuration example illustrated in FIG. 6 includes optical couplers 21 and 22 and optical circulators 23 and 24, and constitutes a Mach-Zehnder interferometer. The optical coupler 21 branches the light arriving from the light source unit 10 in two, outputs the one (the first branch light) to the optical circulator 23 and outputs the other (the second branch light) to the optical circulator 24. The optical circulator 23 outputs the first branch light arriving from the optical coupler 21 to a reference unit 30 and outputs reflected light arriving from the reference unit 30 to the optical coupler 22. The optical circulator 24 outputs the second branch light arriving from the optical coupler 21 to a measurement unit 40 and outputs diffusely-reflected light arriving from the measurement unit 40 to the optical coupler 22. The optical coupler 22 causes the reflected light arriving from the optical circulator 23 and the diffusely-reflected light arriving from the optical circulator 24 to interfere with each other and outputs interference light resulting from the interference to a detection unit 50.

Further, in each of light radiation to a reflector 31 in the reference unit 30 and light radiation to an object 2 in the measurement unit 40, the light may be focused and radiated or may be collimated and radiated. Further, an optical attenuator, an intensity modulator, a polarized wave modulator, a phase modulator or an optical isolator (only a part which propagates light in one direction) may be inserted on light path.

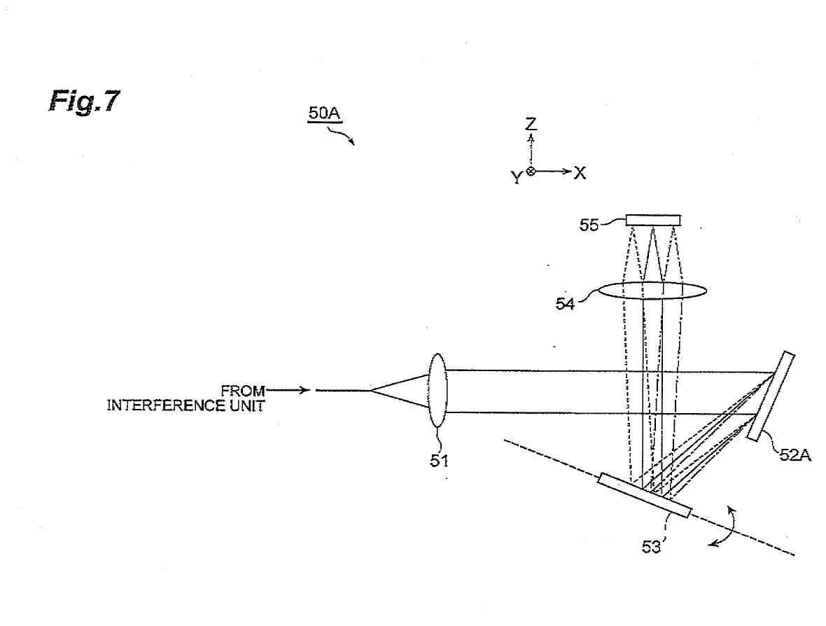

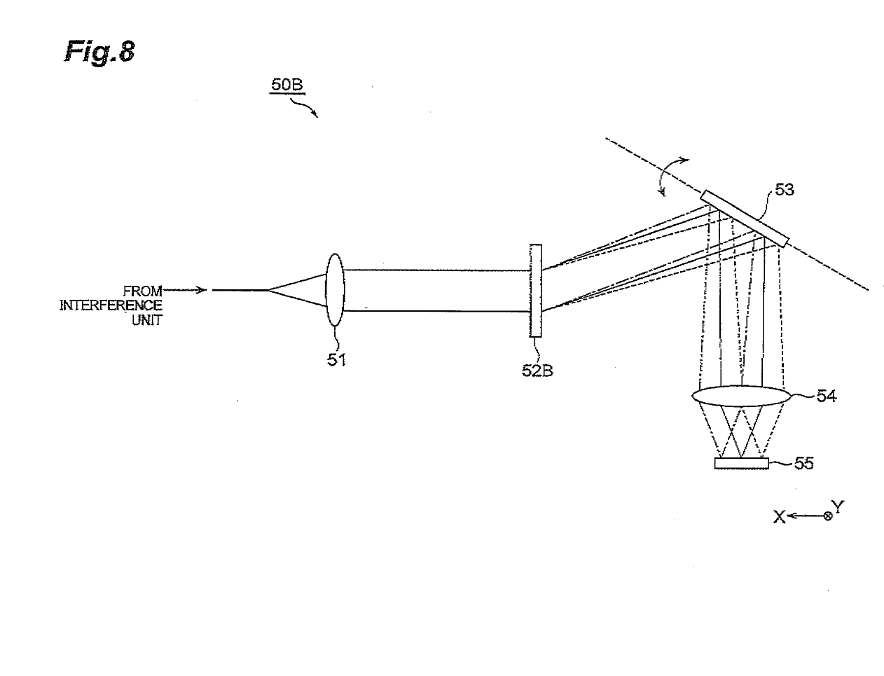

FIGS. 7 and 8 are each diagrams illustrating an example of a configuration of the detection unit 50 of the optical tomographic image acquisition apparatus 1 of the present embodiment.

A detection unit 50A of a first configuration example illustrated in FIG. 7 includes a lens 51, a reflection type diffraction grating 52A, a deflection unit 53, a lens 54 and a light receiving unit 55. The lens 51 collimates interference light output and arriving from the interference unit 20 via an optical fiber, and causes the collimated interference light to be incident on the reflection type diffraction grating 52A. In FIG. 7, it is defined that a traveling direction of the interference light from the lens 51 to the reflection type diffraction grating 52A is an X direction within a paper surface, a direction perpendicular to the paper surface is a

Y direction, and a direction perpendicular to the X direction and the Y direction is a Z direction. The reflection type diffraction grating 52A serving as a spectroscopic unit is a reflection type diffraction grating in which a number of gratings extending in the Y direction on a grating surface perpendicular to an XZ plane (the paper surface) are arranged at a certain period, and divides the interference light collimated and arriving at the lens 51 and outputs the light of each wavelength in a different direction according to the wavelength on the XZ plane.

The deflection unit 53 is rotatable about an axis parallel to the XZ plane, and deflects the light of each wavelength output from the reflection type diffraction grating 52A in a deflection angle direction with respect to the XZ plane. For the deflection unit 53, a Galvano minor or a polygon minor may be used. The lens 54 serving as a focusing unit has an optical axis parallel to the XZ plane and focuses the light of each wavelength deflected by the deflection unit 53 on a light receiving surface of the light receiving unit 55. The lens 54 may be an fθ lens. In this case, a relationship between a position on the light receiving surface of the light receiving unit 55, and a wavelength λ, and a deflection angle becomes a simple proportional relationship. Further, the lens 54 may be a telecentric optical system. In this case, a variation of light focusing ability in each position on the light receiving surface of the light receiving unit 55 is eliminated. The light receiving unit 55 has the light receiving surface perpendicular to the XZ plane and detects power of the light arriving at each position of the light receiving surface on which the light is focused by the lens 54.

A detection unit 50B of a second configuration example illustrated in FIG. 8 differs from the detection unit 50A of the first configuration example shown in FIG. 7 in that a transmission type diffraction grating 52B is included in place of the reflection type diffraction grating 52A, and is the same in the remaining configuration. In either case of the reflection type diffraction grating 52A and the transmission type diffraction grating 52B, there is a relationship expressed by the following expression between an incidence angle θᵢₙ and a diffraction angle θₒᵤₜ of the light with respect to a normal of a diffraction grating surface: sinθᵢₙ+sinθₒᵤₜ=Nmλ. N denotes the number of grooves per unit length of diffraction grating, m denotes a diffraction order, and λ denotes a wavelength.

In the detection unit 50, the interference light output from the interference unit 20 is collimated by the lens 51, divided by the reflection type diffraction grating 52A or the transmission type diffraction grating 52B, and the light of each wavelength is then output in a different direction according to the wavelength on the XZ plane. The light of each wavelength output from the reflection type diffraction grating 52A or the reflection type diffraction grating 52B is deflected in the deflection angle direction with respect to the XZ plane by the deflection unit 53, and focused on the light receiving surface of the light receiving unit 55 by the lens 54. In the light receiving unit 55, power of the light arriving at each position on the light receiving surface on which the light is focused by the lens 54 is detected.

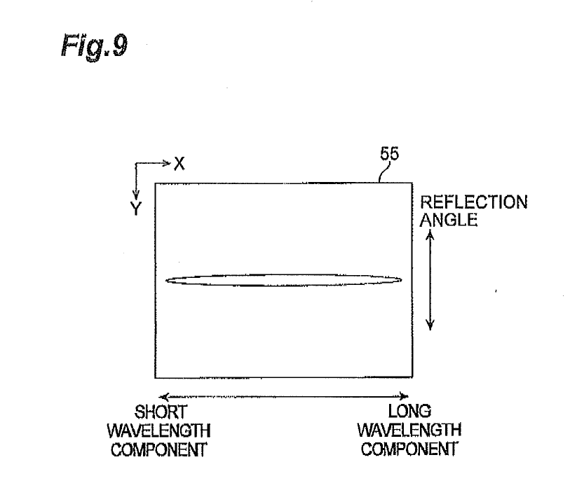

FIG. 9 is a diagram illustrating a state of light receiving in the light receiving unit 55 of the detection unit 50 of the optical tomographic image acquisition apparatus 1 of the present embodiment. When a deflection angle in the deflection unit 53 is constant, a spectrum of interference light parallel to an XZ plane on a light receiving surface of the light receiving unit 55 is obtained, as shown in FIG. 9. Further, when the deflection angle in the deflection unit 53 differs, a Y direction position at which the interference light arrives on the light receiving surface of the light receiving unit 55 differs.

Therefore, in the present embodiment, a radiation position by the scanning unit 41 and the deflection angle by the deflection unit 53 are associated with each other. Also, the analysis unit 60 can obtain an optical tomographic image of the object 2 based on a correspondence relationship between the radiation position by the scanning unit 41 and the deflection angle by the deflection unit 53 and on the optical power distribution detected by the light receiving unit 55. Hereinafter, operation of the present embodiment and an optical tomographic image acquisition method using the optical tomographic image acquisition apparatus 1 in which the object 2 is a blood vessel will be described.

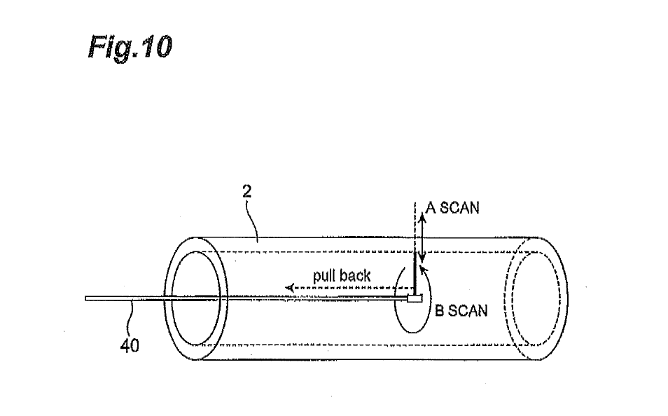

FIG. 10 is a diagram illustrating the measurement unit 40 of the optical tomographic image acquisition apparatus 1 of the present embodiment. Here, tomographic image acquisition in a blood vessel is assumed as an example. The measurement unit 40 includes an optical fiber that guides the second branch light and the diffusely-reflected light, and a tip portion of the optical fiber is inserted into the object 2 (the blood vessel). The second branch light is emitted from the tip portion of the optical fiber to an inner wall of the blood vessel, and the diffusely-reflected light from the blood vessel irradiated with the second branch light is incident on the tip portion of the optical fiber. Further, a position irradiated with the second branch light from the tip portion of the optical fiber is scanned in a peripheral direction and an axial direction of the blood vessel by the scanning unit 41. Further, when the object 2 is a living body, the light source unit 10 can output light in a band including a wavelength range from 1200 nm to 1400 nm (1200 nm or more and 1400 nm or less) or a wavelength range from 1500 nm to 1800 nm (1500 nm or more and 1800 nm or less).

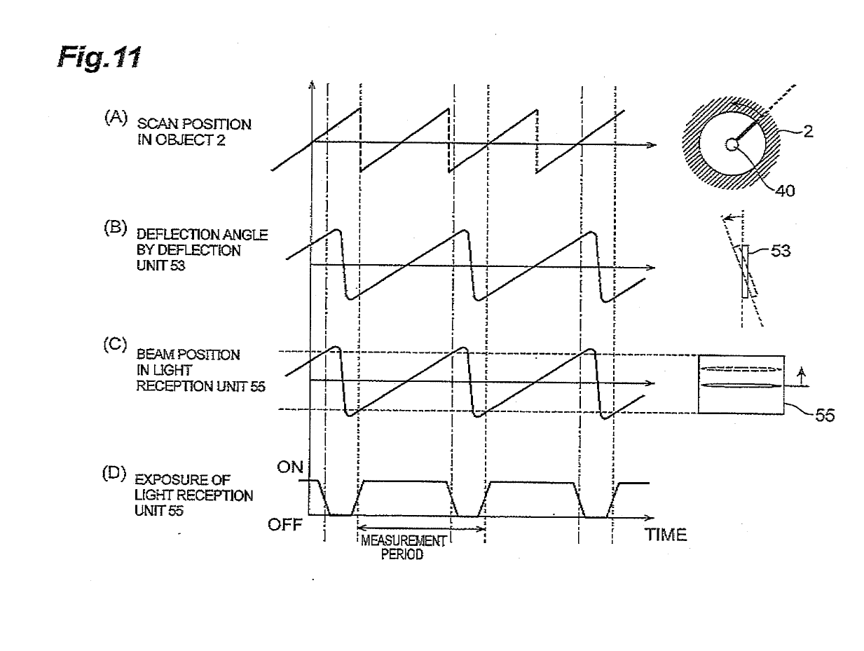

FIG. 11 is a timing chart illustrating operation of the optical tomographic image acquisition apparatus 1 of the present embodiment. In FIG. 11, respective timings of (A) a light radiation position of the peripheral direction in the object 2 (the blood vessel) by the scanning unit 41, (B) a deflection angle by the deflection unit 53, (c) a light incidence position in the Y direction on the light receiving surface of the light receiving unit 55, and (D) on/off of light receiving in the light receiving unit 55 are shown sequentially from the top.

The light receiving unit 55 performs repetitive measurement at a predetermined period, receives light during only a predetermined period of time within one period, and detects a light amount detected in the meantime. The deflection unit 53 is rotated in one direction within this predetermined period of time. In this case, the light arriving at the light receiving surface of the light receiving unit 55 is deflected in the Y direction, but a range of the deflection for an exposure time is adjusted to match a Y direction size of the light receiving surface. Also, if the light radiation position in the peripheral direction in the object 2 (the blood vessel) covers a measurement range while a light arrival position of the light receiving unit 55 is in the entire light receiving surface, information in the depth direction of each scanning position of the object 2 (the blood vessel) can be collectively measured, and a two-dimensional tomographic image in which the depth direction and the peripheral direction scanning direction of the object 2 (the blood vessel) are axes can be acquired in one measurement. Accordingly, speedup of OCT measurement can be achieved.

Further, in FIG. 11, while the case in which the object 2 (the blood vessel) is rotatively scanned with the beam, a reciprocating motion may be performed, or may be changed in speed or stopped at the time of non-exposure. Further, it is desirable for a uniform motion to be performed within an exposure period of time for the light incident position in the Y direction on the light receiving surface of the light receiving unit 55.

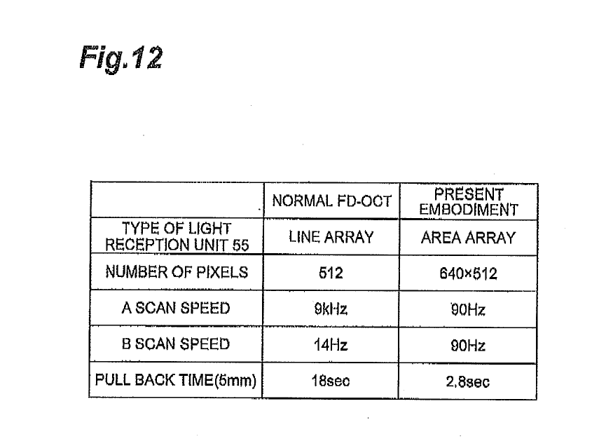

FIG. 12 is a chart summarizing an example of a comparison between a case of the present embodiment and a case of normal FD-OCT. Here, in the case of the normal FD-OCT, the light receiving unit 55 is a one-dimensional sensor of 512 pixels and, in the case of the present embodiment, the light receiving unit 55 is a two-dimensional sensor of 640×512 pixels. In the normal FD-OCT, measurement of one point is performed at 9 kHz, but a speed for measurement over the entire periphery is 14 Hz and 18 seconds are required to measure a length of 5 mm in the axial direction. On the other hand, in the case of the present embodiment, information for one turn is taken in a lump, the speed is 90 Hz, and a time required to measure the length of 5 mm in the axial direction is 2.8 seconds. Thus, in the present embodiment, it is possible to acquire the optical tomographic image of the object 2 at a higher speed than in the normal FD-OCT.

When the tomographic image of the blood vessel is acquired as the object 2, a transparent liquid such as saline is flushed and used in place of blood in order to secure a field of view. In the normal OCT, since a measurement time is taken, it is necessary to temporarily stop (occlude) flow of the blood. However, in the present embodiment, since the measurement can be performed in a short time, the measurement can be performed in a non-occluded state and it is effective in reducing the burden on patients.

### INDUSTRIAL APPLICABILITY

The present invention is applicable to an optical tomographic image acquisition apparatus which can acquire the optical tomographic image of the object at a high speed.

### REFERENCES SIGNS LIST

1: optical tomographic image acquisition apparatus; 2: Object; 10: Light source unit; 20, 20A, 20B, 20C: Interference unit; 30: Reference unit; 31: reflector; 40: Measurement unit; 41: Scanning unit; 50, 50A, 50B: Detection unit; 51: Lens; 52A: Reflection type diffraction grating; 52B: Transmission type diffraction grating; 53: Deflection unit; 54: Lens; 55: Light receiving unit; 60: Analysis unit; 70: Display unit.

1. An optical tomographic image acquisition apparatus, comprising:
a light source unit which outputs light;
an interference unit which branches the light output from the light source unit in two to obtain first branch light and second branch light, irradiates a reflector with the first branch light, receives reflected light from the reflector resulting from the irradiation, irradiates an object with the second branch light, receives diffusely-reflected light from the object resulting from the irradiation, and causes the reflected light from the reflector and the diffusely-reflected light from the object to interfere with each other to output interference light;
a scanning unit which scans a radiation position of the second branch light for the object;
a detection unit which detects the interference light output from the interference unit; and
an analysis unit which analyzes a result of the detection by the detection unit to obtain an optical tomographic image of the object,
wherein the detection unit includes
a spectroscopic unit which divides the interference light output from the interference unit and outputs light of each wavelength in a different direction according to the wavelength on a predetermined plane;
a deflection unit which deflects the light of each wavelength output from the spectroscopic unit in a deflection angle direction with respect to the predetermined plane;
a light focusing unit which focuses the light of each wavelength deflected by the deflection unit; and
a light receiving unit which detects power of light arriving at each position on a light receiving surface on which the light is focused by the focusing unit, wherein
the analysis unit obtains the optical tomographic image of the object based on a correspondence relationship between the radiation position by the scanning unit and a deflection angle by the deflection unit and on optical power distribution detected by the light receiving unit.

2. The optical tomographic image acquisition apparatus according to claim 1, wherein the light source unit outputs light in a band including a wavelength range from 1200 nm to 1400 nm or a wavelength range from 1500 nm to 1800 nm.
